(19) United States
(12) Patent Application Publication
(10) Pub. No.: US 2005/0282977 A1
(43) Pub. Date: Dec. 22, 2005

(54) Cross-linked gel and pressure sensitive adhesive blend, and skin-attachable products using the same

(76) Inventors: Emil Stempel, Northbrook, IL (US); Pak-Tong Leung, Rolling Meadows, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/870,883

(22) Filed: Jun. 17, 2004

(51) Int. Cl. C08L 83/04; B32B 9/04; B32B 27/00

(52) U.S. Cl. 525/477; 428/447

(57) ABSTRACT

A pressure sensitive adhesive composition comprising a compatible blend of (1) a gel preferably comprising a copolymer of an organosiloxane and a siloxane having a plurality of reactive functionalities reacted with a cross-liking agent; and (2) a pressure sensitive adhesive that preferably is essentially non-reactive with the reactive functionalities of said copolymer gel or the copolymer cross-liking agent of said gel, wherein the essentially non-reactive pressure sensitive adhesive is a silicone pressure sensitive adhesive and has a higher adhesive strength than said gel and is blended with said copolymer during cross-linking of said copolymer to form said gel.

### BACKGROUND

Hypo-allergenic pressure sensitive adhesives (PSAs), including silicone-based pressure sensitive adhesives, are well-known in the art. Both acrylic-based and silicone-based pressure sensitive adhesives are widely used in the medical field for dressings, bandages, and other articles or items intended to be adhesively secured to the skin. For example, silicone-based PSAs may reach the user in the form of single component, such as the condensation product of a silanol end-blocked polydimethyl siloxane with a silicate resin, e.g., U.S. Pat. No. 4,591,622, which is usually applied as a liquid and from which its solvent is then allowed to evaporate. Alternatively, the silicone PSA may be provided as a two-component system, with one component being an organopolysiloxane having silicon-bonded hydrogen atoms that are reactive with silicon-bonded vinyl radicals in the presence of a platinum catalyst as disclosed, for example, in U.S. Pat. No. 3,983,298. In any event, such a PSA is characterized in its final form as a viscoelastic material that is aggressively and permanently tacky, adheres without the need for more than finger pressure, and requires no activation by water, solvent or heat.

Silicone PSAs are considered desirable for skin contact from the standpoint that they exhibit relatively high moisture vapor and oxygen transmission, and therefore allow the skin to “breathe.” However, there is a limited choice of commercially available medical grade silicone pressure sensitive adhesives designed for attaching various medical devices, such as waste disposable receptacles, to a human body. During a period of wear time, the load carried by a disposable device may increase, and therefore such a PSA is subjected to larger strains and stresses. As to short term skin contact, they often lack the skinfriendliness needed for frequently repeated removal and replacement. If an aggressive adhesive is applied, some damage to the skin and some discomfort to the user (such as pulling out hairs) often occur. For longer term contact, a less aggressive silicone PSA may fail in its ability to hold an article, for example an ostomy pouch, in place for the required period of time. Again, in the case of longer term use, adequate skinfriendliness (the ability to permit removal of an adhered article without skin or hair damage) may be lacking.

Silicone gels, which are lightly cross-linked silicone polymer networks that are swollen with a fluid, are also well known and may be sufficiently tacky to adhere to the skin for at least limited periods. In recent years, such adhesive silicone gels have been found particularly beneficial as skin-contacting dressings for scar therapy. Reference may be had to Ahn et al, Topical Silicone Gel: A New Treatment for Hypertropic Scars, pages 781-7. Surgery (October 1989) for a discussion of such use.

Published application U.S. 2004/0102744 A1 ('744) discloses using a polysiloxane, a blend of a polysiloxane with a silicate resin, or the reaction product of a polysiloxane and a silicate resin for adhering an ostomy pouch to the skin. The '744 application neither discloses nor suggests the gel/PSA combinations described herein.

U.S. Pat. No. 5,338,490 ('490) discloses a two phase blend including a continuous phase comprising a hydrophillic pressure sensitive adhesive and a discontinuous hydrophobic pressure sensitive adhesive, wherein the hydrophobic pressure sensitive adhesive increases the adhesiveness of the hydrophillic pressure sensitive adhesive. The hydrophillic pressure sensitive adhesive requires a cross-linked solvating polymer, an ionic salt dissolved therein, and a plasticizer. Neither ionic salts nor a plasticizer are required in the blends described herein. The '490 patent neither discloses nor suggests blending a pressure sensitive adhesive with a cross-linkable polymer during the cross-linking of the polymer to form the gel, which compatibilizes the gel/PSA blends described herein.

Unfortunately, adhesive silicone gels, while capable of fully meeting the requirements of skinfriendliness, lack other properties commonly needed for securing loaded attachments, particularly long-term attachments, of articles to the skin. We have found through our studies, for example, that an ostomy wafer which uses an adhesive silicone gel for securing an ostomy pouch to the skin of a wearer, lacks the required strength, adhesive aggressiveness and durability for achieving the desired results, while PSAs, such as the reaction product of a polysiloxane with a silicate resin, are too aggressive causing substantial discomfort in removal.

### SUMMARY

An important aspect of this invention lies in the discovery that while conventional PSAs, including silicone PSAs, used for securing articles to the skin may lack desirable skinfriendliness, and that cross-linked, adhesive gels, including silicone gels, are not considered suitable for that purpose due to insufficient adhesive strength, by blending a PSA with a gel, preferably during gel cross-linking, the gel/PSA blend that results is a superior adhesive which has the properties of skinfriendliness, sufficient strength and duration of attachment, softness and resilience, relatively high moisture vapor transmission rate (MVTR) and oxygen permeability. For these reasons, such a blend is found to be highly effective for any PSA use, particularly for securing devices to human skin, such as body waste collection pouches, e.g., ostomy pouches and fecal and urinary collection pouches.

The preferred silicone gel/silicone PSA blends described herein are useful to adhere waste collectors, dressings, prosthetic and other metal and plastic devices to the body. Examples of such applications include: adhering ostomy appliances, such as ileostomy, colostomy and urostomy appliances to the skin; attaching appliances to the skin for patient monitoring, e.g., heartbeat and brain waves; affixing surgical dressings and pads to the skin; adhering external prosthetic devices; hairpiece adhesion, such as attaching articles to skin (hair-piece to head) for make-up artists and the like; and medical tape. For use in ostomy care, the gel/PSA blends are specifically useful for one piece closed/pouch for short term wear with multiple pouch changes daily for both flat and convex products; drainable one-piece products with either flat or convex barrier for short or long term wear; two piece ostomy care products; pediatric ostomy systems, including one-piece and two piece pouches; stoma cap pouches; skin barrier sheets; skin barrier rings; and paste and skin gel products. For use in continence care, the gel/PSA blends are specifically useful for male external catheters; silicone male external catheters; female continence devices; fecal pouches; retracted penis pouches; and glans caps. For use in wound care, the gel/PSA blends are specifically useful for tube attachment devices such as nasogatric tube attachment devices, endotracheal tube attachment devices and other similar attachment devices; wound care dressings; transparent polyurethane thin film wound dressings; bandages and other wound dressings, e.g., burn dressings; surgical tape, and underlayment tape for athletes hands and ankles; transdermal drug delivery patch systems, e.g., to administer nitroglycerin or other drugs such as morphine, Dramamine, contraceptive drugs and nicotine patch medicaments; scar therapy dressings; island dressings; reclosable wound covers; and foam dressings to secure I.V. needles and catheters to the body; and securing a feeding tube to the breast for breast feeding.

In general, the preferred blend should include from about 0.5% to about 99.5% by weight of a tacky, cross-linked silicone gel, and about 99.5% to about 0.5% of an essentially non-cross-linked pressure sensitive adhesive, particularly any of a variety of known silicone-based pressure sensitive adhesives that have a higher peel strength than the silicone gel. For use in attaching waste collection pouches and other appliances to the skin, a preferred blend is about 40 to 95%, and more preferably 70 to 90%, by weight silicone gel, and 5% to 60%, preferably 10% to 30% by weight more aggressive silicone pressure sensitive adhesive.

In other embodiments, the blend of any cross-linked gel/PSA can be varied over the full range of 0.5% to 99.5% by weight to modify the aggressiveness of the adhesive, as needed, such that the achieved adhesive strength of the blend, always higher than the adhesive strength of the gel alone, reaches a desired level for the particular purpose. Other uses for the gel/PSA blends described herein include coatings for adhesive tapes, and any other article that incorporates a pressure sensitive adhesive.

In accordance with one important embodiment of the gel/PSA blends, methods and articles described herein, it has been found that the adhesive strength of a lightly cross-linked organopolysiloxane gel pressure sensitive adhesive can be controllably increased during manufacture of the gel (during the cross-linking or hydrosilation reaction of an organopolysiloxane) by adding a desired amount of a “more aggressive” silicone pressure sensitive adhesive to a cross-linkable organopolysiloxane and an organopolysiloxane cross-linking (hydrosilation) agent. The “more aggressive” silicone pressure sensitive adhesive is a silicone pressure sensitive adhesive that has more adhesive strength, as measured by a higher peel strength, than the cross-linked silicone gel. In one embodiment, it is theorized that during the cross-linking (addition) reaction of the cross-linking or hydrosilation agent with the organopolysiloxane to form the gel, the more aggressive pressure sensitive adhesive that is in contact with the organopolysiloxane during the cross-linking reaction is mechanically captured by the cross-linked gel during gel formation. In another embodiment, the more aggressive pressure sensitive adhesive is chemically reacted with the organopolysiloxane and/or is lightly cross-linked up to about 20% by weight of its molecules with a cross-linking agent, e.g., the cross-linking agent used to form the gel. It is understood that the term organopolysiloxane includes a siloxane that may be copolymerized with another (non-siloxane) monomer so long as the siloxane units of the copolymer are available for cross-linking.

### DEFINITIONS

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Further, throughout this specification, the components of the silicone gel cross-linking agent, cross-linked gel, and silicone pressure sensitive adhesive are referred to in abbreviated form by letter. The following is a quick reference guide to provide an easier understanding of this specification:

| Abbreviation | gel/PSA blend Component |
|---|---|
| A | Cross-linkable organopolysiloxane |
| B | Cross-linking agent for the organopolysiloxane |
| AB | Cross-linked organopolysiloxane (gel) |
| C | Catalyst for the cross-linking reaction |
| D | Silicone pressure sensitive adhesive |

The soft, tacky skinfriendly adhesive compositions described herein are a blend of (A) a cross-linkable organopolysiloxane; with (B) a cross-linking agent capable of cross-linking the organopolysiloxane (A); (C) a catalyst, if necessary, for the cross-linking reaction; and (D) a silicone pressure sensitive adhesive. In the preferred embodiment, the silicone pressure sensitive adhesive (D) is an organopolysiloxane that is essentially non-reactive (essentially non-cross-linkable) with (A) or (B). What is meant by “essentially non-reactive” or “essentially non-cross-linkable” in defining the preferred (D) component is that (D), when added together with (A), (B), and optionally (C), when necessary to cross-link (A), under conditions sufficient to effect the cross-linking reaction between (A) and (B), will result in a blend comprising gelled, cross-linked (A), and (D), wherein the blend is compatible such that the blend can be mixed to form a homogeneous mixture, with or without an organic solvent, and the blend contains sufficient free (D), that is, (D) that is not cross-linked with (A) or (B)—such that the blend, as well as the PSA (D) taken alone, has more adhesive strength as defined by a higher peel strength according to Pressure Sensitive Tape Council PSTC 101—Method A, than the cross-linked gel (AB) alone. In other words, (D) must have an insufficient number of functional groups that are reactive with (A) or (B) such that molecules of a non-cross-linked, more aggressive silicone, e.g., organopolysiloxane, PSA are entangled within but not covalently bonded to the cross-linked (A) molecules. Preferably, the (D) organopolysiloxane is free of vinyl moieties and silicon-bonded hydrogen atoms so that (D) is not cross-linked during the cross-linking of (A) and (B). However, some (D) molecules, e.g., up to about 20% by weight, preferably less than about 10% by weight, and more preferably less than about 7% by weight, may be cross-linked with (A) or by (B) while providing a compatible mixture having proper PSA rheology, and while increasing the adhesive aggressiveness of the blend beyond the adhesive aggressiveness, e.g., peel strength, of the gelled, cross-linked (AB) component alone.

In another embodiment, the silicone pressure sensitive adhesive (D) combined with the gel (AB) is reactive with the gel (AB) or with the cross-linking agent (B) used to form the gel to provide chemical compatibility.

### BRIEF DESCRIPTION OF THE DRAWINGS

FIG. 1 is a graph showing adhesion to steel peel strength values for blends of the preferred tacky silicone gel and more aggressive silicone pressure sensitive adhesive of Table I applied in various thicknesses and at varied percentages of gel and PSA;

FIG. 2 is a graph showing lap shear peak load strength for the gel/PSA blends of Table I applied in a thickness of 0.330 mm; and

FIG. 3 is a graph showing MVTRs of the gel/PSA blends of Table I in thicknesses of 0.330 mm and 0.635 mm.

### DETAILED DESCRIPTION OF THE PREFERRED EMBODIMENTS

### Cross-Linkable Organopolysiloxane Gel Formation

The cross-linked (AB) gel is formed while in contact with the essentially non-cross-linkable (D) component by an addition reaction between an organopolysiloxane and a cross-linking agent for the organopolysiloxane. The cross-linkable organopolysiloxane may be any organopolysiloxane that has one or more functionalities, e.g., vinyl, silanol, or hydroxyl groups, either as end groups or as pendant functionalities extending from the organopolysiloxane backbone. The organopolysiloxane (A) is cross-linked sufficiently to form a pressure sensitive adhesive gel when swollen with an organic solvent or fluid, typically a siloxane fluid.

The cross-linkable organopolysiloxane material (A) has the general formula (I), as follows: 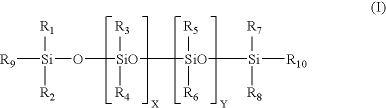
, wherein X and Y are positive integers, same or different, of at least 1, and wherein any one or more of R₁-R₁₀ is a cross-linking agent-reactive functional group, e.g., vinyl, OH, alkoxy having 1-4 carbon atoms, ketoxime, aminoxy, acetamido, N-methylacetamide, acetoxy and/or acetamido radicals, preferably one or more vinyl groups extending from the silicone polymer backbone (R₃, R₄, R₅, and/or R₆).

The preferred organopolysiloxane material (A) is a poly(diorganosiloxane-co-vinylsiloxane) copolymer cross-linked with the preferred cross-linking agent (B), a methylhydrogensiloxane.

Suitable radicals for R₁-R₁₀ include monovalent hydrocarbon radicals, for example, methyl, ethyl, propyl, butyl, phenyl, and other similar saturated hydrocarbons, wherein at least one of R₁-R₁₀ is a moiety that is reactive with the cross-linking agent, such as a hydrocarbon radical having alkenyl unsaturation. Typically, the one or more Rs that contain an alkenyl unsaturation contain a vinyl group, but the alkenyl unsaturation may also be an allylic or cyclo-alkenyl unsaturated group. X and Y are positive integers so that, preferably, the polysiloxane has up to approximately 20% by weight groups reactive with a suitable cross-linking agent.

Preferably at least one of R₃, R₄, R₅ or R₆ is an alkene having 2-8 carbon atoms or a cycloalkene having 5-7 carbon atoms, or styrene. R₉ and R₁₀, same or different, may be H, OH, C₁-C₁₀ alkyl, end-blocking siloxyl, a hydrocarbon radical having alkenyl unsaturation, e.g., CH═CH₂, or the like. The preferred copolymer is a silanol or vinyl end-blocked poly(dimethylsiloxane-co-vinylsiloxane) wherein one of R₃, R₄, R₅ or R₆ is CH═CH₂.

The preferred vinyl chainstopped polysiloxane has the formula 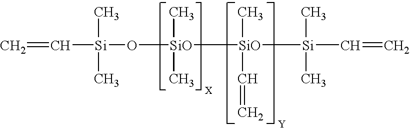
where X and Y are positive integers so that the vinyl chainstopped polysiloxane has up to approximately 20% by weight, preferably 1-10%, more preferably 2-6% of CH═CH₂ groups. The preferred viscosity of such a polysiloxane ranges from approximately 50 to approximately 100,000 milliPascal-seconds (mPa-s) at 25° C. Preferably, the vinyl chainstopped polysiloxane has a viscosity ranging from approximately 300 to approximately 550 mPa-s at 25° C.

A methylhydrogen siloxane fluid, e.g., a polymethylhydrogen siloxane fluid, is the preferred cross-linking agent (B). Polyphenylsiloxane fluid also can be used as the cross-linking agent. Particularly useful as a cross-linking agent is a trimethyl chainstopped polymethylhydrogen siloxane fluid having from approximately 10% to approximately 100% SiH groups and having a viscosity in the range of approximately 25 to approximately 1,000 mPa-s at 25° C. Other cross-linking agents and methods suitable for cross-linking the reactive organopolysiloxane to form a gel, in-situ, while in contact with the more aggressive, essentially non-cross-linkable silicone PSA include, 0.5-3% by weight of a peroxide catalyst, such as benzoyl peroxide or 2,4-dichlorobenzoyl peroxide, based on adhesive solids, for cross-linking at 110° C. to 200° C. for 1 to 10 minutes. However, the cross-linking agent should not be significantly reactive with the more aggressive, organopolysiloxane component (D) described herein. Other free radical cross-linking methods such as electron beam or actinic radiation may be useful for cross-linking, particularly when the reactive organopolysiloxane contains aliphatically unsaturated radicals, such as vinyl radicals. When the reactive organopolysiloxane and/or end-blocking triorganosilyl units contain aliphatically unsaturated radicals, such as vinyl radicals, the organopolysiloxane can be cured at room temperature or by heating, or by using an SiH bearing co-reactant in conjunction with a chloroplatinic acid catalyst in the well-known manner.

The cross-linking reaction which takes place between the cross-linkable organopolysiloxane (A) and the preferred polymethylhydrogensiloxane fluid cross-linking agent (B) is an addition reaction, also known as a hydrosilation. The cross-linkable organopolysiloxane (A) may be thermally cross-linked by means of a platinum (hydrosilation) catalyst. The catalyzed cross-linking reaction occurs, for example, between pendant vinyl groups of a dialkylvinyl chainstopped polydialkyl-alkylvinylsiloxane copolymer, or an organopolysiloxane containing a reactive group, e.g., vinyl group, that is pendant to the organopolysiloxane backbone. The preferred trimethyl chainstopped polymethylhydrogensiloxane cross-linking fluid has from approximately 10% to approximately 100% SiH groups and has a viscosity in the range of approximately 25 to approximately 1,000 mPa-s at 25° C. The preferred cross-linking agent should have an average of greater than two silicon bonded hydrogen atoms per molecule of cross-linking agent, with no silicon atom bearing more than one silicon bonded hydrogen atom, and the amount of cross-linking agent present being sufficient to provide from 1.0 to 20.0 silicon bonded hydrogen atoms for every olefinically unsaturated radical, or other reactive functional group, in the cross-linkable organopolysiloxane.

A useful catalyst for facilitating the hydrosilation cross-linking reaction is the Lamoreaux catalyst as described in U.S. Pat. No. 3,220,972. Other platinum-metal catalysts can also be utilized and their selection depends upon such factors as speed of the reaction required as well as expense, useful shelf-life, useful pot-life and the temperature at which the cross-linking reaction is to take place. Such platinum-metal catalysts include those which utilize the precious metals ruthenium, rhodium, palladium, osmium, iridium and platinum, and complexes of these metals. The amount of catalyst ranges from about 10 to about 500 ppm. Preferably, the amount of catalyst is approximately 10-50 ppm of precious metal.

### The Preferred More Aggressive PSA

Any essentially silicone pressure sensitive adhesive that is more aggressive (has a higher peel strength) than the gel alone, and is compatible with the gel, is useful to form the pressure sensitive adhesive blends described herein. In the preferred embodiment, the more aggressive silicone pressure sensitive adhesive is essentially non-cross-linkable, and should be essentially non-reactive with the gel components (A) and (B). The blend of gel and more aggressive PSA maintains a higher peel strength than that of the gel alone. During cross-linking of the cross-linkable organopolysiloxane with the cross-linking agent to form the gel, the more aggressive silicone PSA is compatiblized during gel formation (becomes mixable with the gel to form a homogeneous composition of the gel with the more aggressive PSA) to provide a homogeneous blend having the proper rheology for a PSA, while being surprisingly highly skinfriendly, e.g., will not cause hair removal or pain when removed from the skin, and providing unexpectedly long adherence to the skin, even through multiple showers.

The preferred, more aggressive silicone pressure sensitive adhesive is a pre-reacted non-cross-linkable pressure sensitive adhesive formed by the condensation reaction between (1) a benzene soluble, reactive functionality-containing resin, e.g., hydroxyl-containing organopolysiloxane resin and (2) a reactive organopolysiloxane, e.g., a hydroxyl-functional polydimethylsiloxane. In the preferred embodiment, the more aggressive silicone PSA (D), for admixture with the cross-linkable organopolysiloxane (A) and cross-linking agent (B) during cross-linking to form the gel, should be essentially non-reactive with the cross-linkable organopolysiloxane (A) or its cross-linking agent (B) that react to form the gel (AB). One example of a reactive functionality-containing siloxane resin consists essentially of R₃SiO_{1/2} siloxane units and SiO_{4/2} siloxane units, wherein R is a monovalent hydrocarbon radical having 1 to 10 carbon atoms; there being from 0.5 to 1.5 R₃SiO_{1/2} units for every SiO_{4/2} units, and there being 1 to 10 wt %, preferably 1 to 7 wt %, hydroxyl functionality in the resin structure, based on FTIR. The preferred reactive organopolysiloxane for the condensation reaction with the siloxane resin is a reactive functionality-containing polydiorganosiloxane having a viscosity of ≧100 MPa-s. The siloxane resin and reactive organopolysiloxane are mixed and heated until the desired properties of the silicone pressure sensitive adhesive have been achieved, as well known in the art.

The preferred resin is a benzene soluble, hydroxyl-containing organopolysiloxane resin. The preferred organopolysiloxane resin should contain from 1 to 10 wt %, preferably 1 to 7 wt %, hydroxyl functionality, more preferably from 2 to 5 wt % hydroxyl functionality, based on resin solids, as determined by FTIR. The organopolysiloxane resin includes a resinous portion wherein the R₃SiO_{1/2} siloxane units (M units) are bonded to the SiO_{4/2} siloxane units (Q units), each of which is bonded to at least one other SiO_{4/2} siloxane unit; wherein R is selected from the group consisting of hydrocarbon radicals and halogenated hydrocarbon radicals. Some SiO_{4/2} siloxane units may be bonded to hydroxyl radicals, resulting in HOSiO_{3/2} units (i.e., TOH units), thereby accounting for any silicon-bonded hydroxyl content of the organopolysiloxane resin. In addition to the resinous portion, the organopolysiloxane resin can contain a small amount of a low molecular weight material comprised substantially of a neopentamer organopolysiloxane having the formula (R₃SiO)₄Si, the latter material being a byproduct in the preparation of the resin.

The preferred ratio of R₃SiO_{1/2} siloxane units to SiO_{4/2} siloxane units in the siloxane resin is a molar ratio of 0.5 to 1.5. It is preferred that the molar ratio of the total M siloxane units to total Q siloxane units of the organopolysiloxane resin be between 0.6 and 1.1.

In the formula for the organopolysiloxane resin, R denotes a monovalent radical selected from the group consisting of hydrocarbon and halogenated hydrocarbon radicals having from 1 to 10 carbon atoms, and most preferably having from 1 to 6 carbon atoms. Examples of suitable R radicals include alkyl radicals, such as methyl, ethyl, propyl, pentyl, and octyl; cycloaliphatic radicals, such as cyclohexyl; aryl radicals such as phenyl, tolyl, xylyl, benzyl, alpha-methyl styryl and 2-phenylethyl; alkenyl radicals such as vinyl; and chlorinated hydrocarbon radicals such as 3-chloropropyl and dichlorophenyl.

Preferably, at least one-third, and more preferably substantially all radicals R are methyl and/or phenyl radicals. Examples of preferred R₃ SiO_{1/2} siloxane units include Me₃ SiO_{1/2}, ViMe₂ SiO_{1/2}, PhMe₂ SiO_{1/2} and Ph₂ MeSiO_{1/2} where Me hereinafter denotes methyl and Ph hereinafter denotes phenyl.

It is preferred that the resinous portion of the organopolysiloxane resin have a number average molecular weight (Mn) of about 1,500 to 15,000 when measured by gel permeation chromatography (GPC). This molecular weight is preferably above about 3,000, most preferably 3,500 to 6,500.

By the term “benzene soluble”, as well as known in the art, it is meant that the organopolysiloxane resin can be dissolved substantially completely, in either a hydrocarbon liquid such as benzene, toluene, xylene, heptane or the like, or in a silicone liquid such as cyclic or linear polydiorganosiloxanes. Preferably the resin is soluble in a hydroxyl functional group-containing polydiorganosiloxane.

The organopolysiloxane resin can be prepared by well known methods. It is preferably prepared by the silica hydrosol capping process of U.S. Pat. No. 2,676,182 to Daudt et al.; as modified by U.S. Pat. No. 3,627,851 to Brady; and U.S. Pat. No. 3,772,247 to Flannigan; each patent being incorporated herein by reference to teach how to prepare soluble organopolysiloxanes which are useful to prepare the preferred more aggressive silicone PSA. The resulting resin can be used without further modification or it can be capped with trialkylsilyl or any other end blocking group that is reactive with the reactive organopolysiloxane used in making the more aggressive, non-cross-linkable silicone pressure sensitive adhesive. This can be accomplished by well known methods, such as reacting the resin with a compound such as trimethylchlorosilane or hexamethyldisilazane.

Methods for reducing the silanol content in organopolysiloxane resins are well known in the art. In another embodiment of the more aggressive silicone PSA useful herein, the silanol content in the organopolysiloxane resin may be reduced by first preparing an untreated resin and thereafter treating an organic solvent solution of the resin with a suitable end-blocking agent to reduce the amount of silicon-bonded hydroxyl groups. End-blocking agents capable of providing end-blocking triorganosilyl units are commonly employed as silylating agents and a wide variety of agents are known and disclosed in U.S. Pat. Nos. 4,584,355 and 4,591,622 to Blizzard, et al., and U.S. Pat. No. 4,585,836 to Homan, et al. which are hereby incorporated by reference. A single end-blocking agent such as hexamethyldisilazane can be used or a mixture of such agents can be used. The procedure for treating the resin may be simply to mix the end-blocking agent with a solvent solution of the resin and allowing the byproducts to be removed. Preferably, an acid catalyst is added and the mixture is heated to reflux conditions for a few hours.

The preferred reactive organopolysiloxane, for reaction with an organopolysiloxane resin to make the more aggressive silicone pressure sensitive adhesive, is a hydroxyl-containing polydiorganosiloxane polymer, preferably a hydroxyl-terminated polydiorganosiloxane polymer. The repeat units of the polymer are RSiO_{2/2} siloxane units wherein R is the same as described above for the organopolysiloxane resin. The reactive polydiorganosiloxane can be comprised of a single polymer or copolymer or it can be a mixture of two or more such polymers or copolymers. The reactive polydiorganosiloxane should have a viscosity at 25° C. of about ≧100 mPa-s. It is preferable to use reactive polydiorganosilixoanes, for the condensation reaction with the reactive resin, that have a viscosity of between 100 and 1,000,000 mPa-s, more preferably between 1,000 and 500,000 mPa-s. The reactive polydiorganosiloxane can have a viscosity of >1,000,000 mPa-s. Polydiorganosiloxanes having a viscosity of >1,000,000 mPa-s are typically gums and their viscosity may be represented in terms of plasticity where plasticity is a measure of the resistance of flow of the polymer when placed under a constant load for a period of time.

Any more aggressive silicone pressure sensitive adhesive, regardless of solids content, can be blended with the adhesive silicone gel in accordance with the compositions and methods described herein. In the preferred embodiment, the more aggressive silicone PSA is high in solids—the PSA has ≧50 wt % non-volatile components, preferably ≧60 wt. %, more preferably ≧75 wt %, in a solvent. Preferably the preferred high solids silicone pressure sensitive adhesive has a viscosity of ≦300,000, preferably ≦100,000 mPa-s, wherein said viscosity is the viscosity of the solvent-based composition (PSA and solvent). Polydiorganosiloxanes having a viscosity of greater than 1,000,000 mPa-s may be combined with solvents, such as ethyl acetate, to lower the viscosity of the pressure sensitive adhesives, and to control the PSA rheology.

It is preferred that at least 50%, and preferably at least 85%, of the organic radicals along the chain of the reactive polydiorganosiloxane (reactive with the organopolysiloxane resin) are methyl and/or phenyl radicals, which can be distributed in any manner in the reactive organopolysiloxane. Further, the reactive polydiorganosiloxane can comprise up to about 10 mole percent of siloxane branching sites provided it meets the above viscosity requirements. The preferred reactive polydiorganosiloxane, for reaction with the organopolysiloxane resin, is a hydroxyl-end-blocked polydimethylsiloxane.

In the preferred embodiment of the more aggressive silicone PSA, the organopolysiloxane resin is employed in an amount from about 40 to 70 parts by weight of the more aggressive silicone pressure sensitive adhesive, and the reactive polydiorganosiloxane is employed in an amount from about 30 to about 60 parts by weight, wherein the total parts of the organopolysiloxane resin and the reactive polydiorganosiloxane are 100 parts. It is preferred that the organopolysiloxane resin be employed from about 50 to 60 parts by weight, and correspondingly, the reactive polydiorganosiloxane be employed from about 40 to 50 parts by weight, wherein the total parts by weight equals 100.

Tests were conducted on the preferred blend containing varied percentages of the preferred organopolysiloxane gel material formed by cross-linking a poly(dimethylsiloxane-co-vinylsiloxane) (NuSil MED 6345 Part A) cross-linked with a polyhydrogenmethylsiloxane (NuSil MED 6345 Part B) cross-linking agent to form a gel; and the preferred more aggressive organopolysiloxane PSA (Dow Corning MD7-4602) which is an essentially non-cross-linkable polydimethylsiloxane that is the condensation reaction product of a silanol end-blocked polydimethylsiloxane with a hydroxyl-functional polydimethylsiloxane resin (pre-reacted). In all tests of the blends described herein, the gel was formed (the organopolysiloxane was cross-linked) while in the presence of (in contact with) the more aggressive, essentially non-reactive silicone pressure sensitive adhesive.

### EXPERIMENTAL

Materials:

(1) MED 6345 (two component gel kit: Part A-organopolysiloxane and Part B-methylhydrogensiloxane cross-linking agent—10% active) from NuSil Silicone Technologies

(2) MD7-4602 Pressure Sensitive Adhesive from Dow Corning,—60% solids, having a peel test value higher than the MED 6345 gel kit PSA

These materials can be mixed either by weighing each single component and mixing them together, or by dosing each single component by volume and mixing them in line with the use of a “static mixer” just before dispensing.

Three ways have been used to mix the silicone adhesive materials:

(1) Stainless steel spatula (mixed by hand).

(2) Laboratory Ross Emulsifying Mixer with a “disintegrating head”.

(3) A static mixer, such as a MIXPAC or PLAS-PAK static mixer.

Stainless Steel Spatula

In the laboratory setting MED 6345 components: Part A and Part B can be mixed entirely with the use of a hand held stainless steel spatula, or a motor driven propeller. For example, 50.1 g each of Part A and Part B of NuSil MED 6345 were weighted and placed into a disposable plastic beaker. After mixing at room temperature for about two (2) minutes with the use of a motor driven propeller, 25.0 g of the NuSil Part A and Part B blend were mixed by hand with 5.0 g of MD7-4602. The resultant mixture was coated on a piece of polyurethane film (Medifilm 426) 0.013 mm thick and heated for 45 minutes at 100° C. in a forced air oven. After curing for 45 minutes, the resultant material was flexible and tacky to the touch; did not leave any residue on the skin upon removal; adhered to skin more tenaciously than MED 6345 used alone; and cured under the same conditions as MED 6345 alone. Other blends of MED 6345 and MD7-4602 were mixed together at concentrations ranging from 5% to 95% of MD7-4602 on a dry basis, in MED 6345, and the MD7-4602 and MED 6345 materials were tested alone. All cured blends exhibited increased tack to the touch compared to the gel MED 6345 cured alone.

The mixing process is quite robust. It is possible to mix all three components: Part A and Part B of MED 6345 and MD7-4602 by hand if the individual components are pre-weighed; or it can be done, for example, with the use of a Laboratory Ross Emulsifying mixer.

Laboratory ROSS Mixer Emulsifier

Charles Ross and Sons Company makes emulsifying mixers with various attachments to affect the degree at which the mixed materials can be mixed. The mixer works well, producing short mixing cycles. For example, a 250 g batch of silicone gel adhesive that consisted of equal amounts of Part A and Part B, e.g., 112.5 g each, MED 6345 and 41.7 g of MD7-4602 were mixed in the lab Ross Emulsifying Mixer within a 1.5-2 minute period at room temperature. A significant amount of air was entrained during mixing, but surprisingly at lower contents of MD7 4602 no degassing was required prior to coating. After curing at 100° C. for 30 minutes the resultant 0.330 mm thick adhesive web, drawn onto 0.013 mm paper supported polyurethane, was consistently tacky without air pockets embedded.

MIXPAC Static Mixer

Mixing processes described in previous paragraphs addresses mixing in which all components have been pre-weighed. An alternative mixing technique is to dose and mix the materials based on volumes. The Mixpac Company supplies plastic disposable cartridges suitable for mixing two components with the use of a static mixer. 24.8 g of each of Part A and Part B of MED 6345 were premixed with a spatula and about half of the pre-mixed Part A and Part B MED 6345 (24.8 g) blend was placed in one tube of a 50 ml Mixpac static mixer cartridge. A weight of 24.8 g of the Part A and Part B blend of MED 6345 is equivalent to about 25.3 ml by volume. In the second smaller diameter tube of the same Mixpac static mixer cartridge, 4.9 g of MD7-4602, were placed. A weight of 4.9 g of MD7-4602 corresponds to a volume of about 4.4 ml. The relative ratio of the volumes of MED 6345 silicone PSA gel-forming material to the more aggressive, essentially non-reactive silicone PSA was 25.3 ml/4.4 ml=5.8. The overall volumetric ratio between these two cartridge tubes was also 5.8. The cartridge tip was fitted with 6.35 mm diameter tubing, about 14 cm long, that contained 21 mixing elements. The material was dispensed from the cartridge through the static mixer using a properly fitting plunger. The dispensed material was coated on 0.013 mm polyurethane film and cured at 100° C. for 30 minutes. The cured material surface appeared solid, and tacky to the touch.

The molecular weights of the blended components and Platinum (Pt) hydrosilation catalyst content of each component were as follows:

| | Mn | Mw | Mz | Pt (ppm) |
|---|---|---|---|---|
| Component | (number average) | (weight average) | (z average) | (catalyst) |
| NuSil MED 6345 Part A | 62,900 | 98,200 | 145,000 | 12 |
| gel-forming cross-linkable | | | | |
| organopolysiloxane | | | | |
| NuSil MED 6345 Part B | 35,100 | 52,000 | 69,200 | <0.85 |
| cross-linking agent | | | | |
| Dow MD7-4602 | 71,200 | 152,000 | 313,000 | <0.69 |
| more aggressive, essentially non- | | | | |
| cross-linkable | | | | |
| organopolysiloxane pressure | | | | |
| sensitive adhesive | | | | |

The poly(dimethylsiloxane-co-vinylsiloxane) copolymer (MED 6345); the polyhydrogensiloxane (MED 6345 cross-linking agent); and the more aggressive PSA, a condensation product of a silanol end-blocked polydimethylsiloxane with a silicate resin having silicon-bonded hydroxyl-functionalities (MD7-4602) were mixed by hand at varied weight percentages of gel to PSA and then heated at 100° C. for 30 minutes to effect cross-linking of the copolymer while in intimate contact with the essentially non-cross-linkable organopolysiloxane PSA component. The resultant mixture was coated on polyurethane film (Medifilm 426) 0.013 mm thick and heated for 30 minutes at 100° C. in a forced air oven. A number of peel strength tests were performed at varied percentages of the gel (NuSil 6345 Part A cross-linked in situ with NuSil 6345 Part B mixed in a 1:1 weight ratio) and the essentially non-cross-linkable, more aggressive organopolysiloxane PSA (Dow MD7-4602).

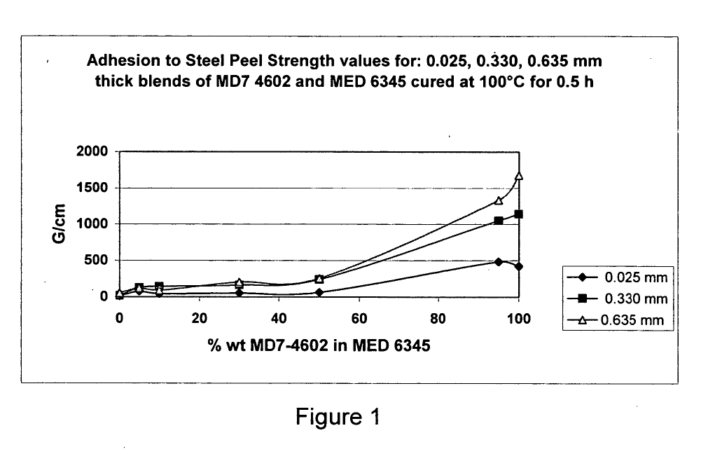

The gel/PSA blends at varied weight percentages of gel and more aggressive PSA were tested for Adhesion To Steel, testing the Peel Strength of Pressure Sensitive Adhesive Tapes according to PSTC 101 Method A by applying the blend to a 2.54 cm wide duct tape at gel/PSA blend thicknesses of: 0.025 mm, 0.330 mm, and 0.635 mm. The data (Examples 1-21) are shown in Table I and FIG. 1.

TABLE I
PEEL STRENGTH

| | Example No. | | | | | | | | | | |
|---|---|---|---|---|---|---|---|---|---|---|---|
| | 1 | 2 | 3 | 4 | 5 | 6 | 7 | 8 | 9 | 10 | 11 |
| % wt. MD6-4602 in MED 6345 | 0 | | | 5 | | | 10 | | | 30 | |
| Thickness (mm) | 0.025 | 0.330 | 0.635 | 0.025 | 0.330 | 0.635 | 0.025 | 0.330 | 0.635 | 0.025 | 0.330 |

Adhesion to Steel Peel Strength (g/cm)

| | | | | | | | | | | | |
|---|---|---|---|---|---|---|---|---|---|---|---|
| Average | 14.30 | 16.09 | 53.62 | 76.87 | 126.9 | 121.5 | 42.90 | 144.8 | 91.16 | 51.83 | 164.4 |
| Standard Deviation | 1.79 | 5.36 | 14.30 | 14.30 | 32.17 | 10.72 | 12.51 | 69.71 | 10.72 | 32.17 | 19.66 |

PEEL STRENGTH

| | Example No. | | | | | | | | | |
|---|---|---|---|---|---|---|---|---|---|---|
| | 12 | 13 | 14 | 15 | 16 | 17 | 18 | 19 | 20 | 21 |
| % wt. MD6-4602 in MED 6345 | 30 | 50 | | | 95 | | | 100 | | |
| Thickness (mm) | 0.635 | 0.025 | 0.330 | 0.635 | 0.025 | 0.330 | 0.635 | 0.025 | 0.330 | 0.635 |

Adhesion to Steel Peel Strength (g/cm)

| | | | | | | | | | | |
|---|---|---|---|---|---|---|---|---|---|---|
| Average | 205.5 | 62.55 | 241.3 | 253.8 | 484.4 | 1051 | 1332 | 423.6 | 1142 | 1678 |
| Standard Deviation | 23.24 | 12.51 | 42.90 | 21.45 | 116.2 | 198.4 | 395.0 | 143.0 | 44.68 | 443.3 |

```
Materials: gel/PSA blends
Components: MD7-4602 Dow Corning
          MED 6345, Nusil Silicone Technologies gel components
Backing: 0.013 mm thick Polyurethane Medifilm 426 from Mylan
        Polyken 2.54 cm wide green tape from Tyco Adhesives
Conditioned for 24 hours at 22° C. and 50% relative humidity prior to testing
Number of samples tested for each example = 7
Test: PSTC 101-- Method A; Adhesion to Steel Plates with backing tape
```

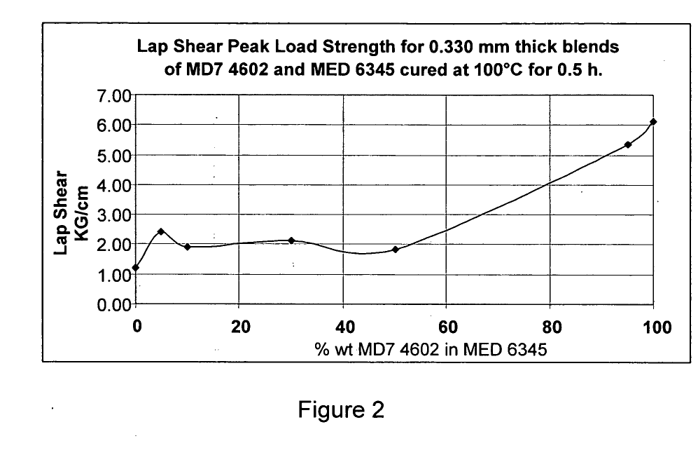

The same gel/PSA blends, mixed, polymerized and cross-linked in the same manner as described with reference to the data of Table I, were tested for Lap Shear Peak Load at varied weight percentages of gel and more aggressive PSA. The gel/PSA blends were applied in a thickness of 0.330 mm on a polyester film, and conditioned for 24 hours at 22° C. and 50% relative humidity prior to testing. The data (Examples, 22-28) are shown in Table II and FIG. 2.

TABLE II
LAP SHEAR

| | Example No. | | | | | | |
|---|---|---|---|---|---|---|---|
| | 22 | 23 | 24 | 25 | 26 | 27 | 28 |
| % Wt MD7-4602 | 0 | 5 | 10 | 30 | 50 | 95 | 100 |
| in MED 6345 | | | | | | | |

Lap Shear Peak Load (Kg/cm)

| | | | | | | | |
|---|---|---|---|---|---|---|---|
| Average | 1.20 | 2.42 | 1.89 | 2.13 | 1.83 | 5.36 | 6.13 |
| Standard | 0.22 | 0.36 | 0.45 | 0.45 | 0.34 | 0.22 | 0.52 |
| Deviation | | | | | | | |

Materials: gel/PSA blends
Components: MD7-4602 Dow Corning
MED 6345, Nusil Silicone Technologies gel components
Backing: 0.050 mm clear Polyester
Thickness: 0.330 mm
Conditioned for 24 hours at 22° C. and 50% relative humidity prior to testing
Number of samples tested for each example = 7
Test: ASTM D-3163-96 Lap Shear

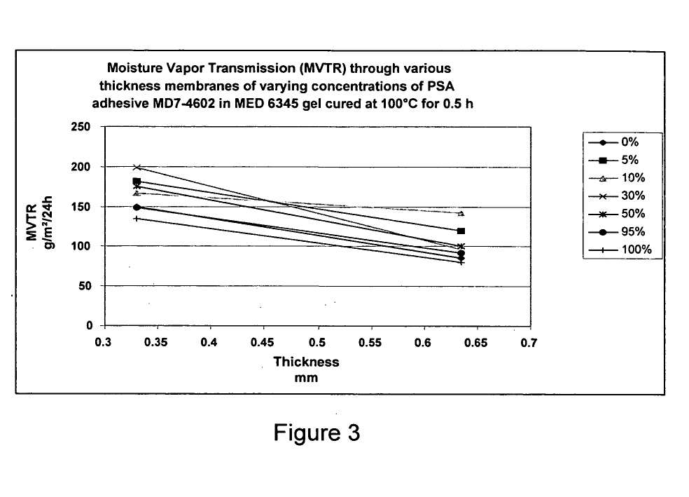

The same gel/PSA blends were then tested (ASTM E-96-80) for moisture vapor transmission at varied weight percentages of gel and more aggressive PSA, and at varied thicknesses of the gel/PSA blend. The data (Examples 29-35) are shown in Table III and FIG. 3.

TABLE III

| | | Moisture Vapor Transmission (g/m²/24 h) | | | | | | |
|---|---|---|---|---|---|---|---|---|
| | | Example No. | | | | | | |
| | | 29 | 30 | 31 | 32 | 33 | 34 | 35 |
| | | % wt. MD7-4602 in MED 6345 | | | | | | |
| Thickness (mm) | | 0% | 5% | 10% | 30% | 50% | 95% | 100% |
| 0.330 | Average | 150 | 182 | 167 | 199 | 175 | 148 | 135 |
| | Standard | 5.1 | 1.4 | 6.3 | 6.3 | 14.4 | 25.7 | 11.7 |
| | Deviation | | | | | | | |
| 0.635 | Average | 85 | 120 | 142 | 96 | 100 | 92 | 80 |
| | Standard | 16.3 | 11.0 | 11.9 | 6.5 | 5.4 | 2.8 | 2.4 |
| | Deviation | | | | | | | |

Materials: gel/PSA blends
Components: MD7-4602 Dow Corning
MED 6345, Nusil Silicone Technologies gel components
Liners: 0.013 mm Polyurethane Film, Medifilm 426 from Mylan
Test Conditions: 24 hours at 37.7° C. and 50% relative humidity
Number samples tested for each example = 3
Test: ASTM E-96-80

As shown in Table III, the gel/PSA blends (at 5% to 95% of either the gel or the more aggressive PSA) showed surprisingly higher moisture vapor transmission rates (MVTRs) than either the gel or PSA alone.

Two gel/PSA blends were tested in user studies to examine the security of the blended adhesive in attaching weighted ostomy appliances, having 0.330 mm thicknesses of the two gel/PSA blends, to the skin of test subjects over a median period of 12.5 hours. The first gel/PSA blend (X) was a blend of 90% silicone gel and 10% more aggressive silicone pressure sensitive adhesive, and the second gel/PSA blend (Y) was a blend of 70% silicone gel and 30% more aggressive pressure sensitive adhesive. The objective of the study was to determine if the gel/PSA blends would maintain secure attachment of weighted ostomy bags to the skin of the test subjects over a 12 hour period and through a shower without failure. The test period of at least 12 hours without failure indicates that the adhesive provides a highly secure attachment for the weighted ostomy appliances for a sufficient duration since ostomy appliances, particularly closed ostomy appliances, usually are changed within a 12 hour period. The user study information obtained, therefore, was especially relevant to the gel/PSA blends described herein providing a highly secure attachment as well as providing ease of removal. There were no reports of the pouches, attached with either gel/PSA blend X or Y, falling off during the test period, which included showering.

As to skinfriendliness, the test subjects were asked to rate the comfort of the pouches, adhered with gel/PSA blends X and Y, while wearing, and during removal, and were asked to rate the ease of removal. The comfort rating during wearing and removal, as well as the ease of removal, as shown by the responses in Table IV below, was notably positive:

TABLE IV

| | |
|---|---|
| gel/PSA blend X Test | gel/PSA blend Y Test |
| Subjects' Response (%) | Subjects' Response (%) |

1. Test Subjects' Rating of Comfort While Wearing

| | | |
|---|---|---|
| Very Comfortable | 30.8 | 32.7 |
| Comfortable | 38.5 | 34.6 |
| Neither comfortable | 30.8 | 32.7 |
| or uncomfortable | | |
| Uncomfortable | — | — |
| Very uncomfortable | — | — |

2. Test Subjects' Rating of Ease of Removal.

| | | |
|---|---|---|
| Very Easy | 4.0 | 5.9 |
| Easy | 48.0 | 29.4 |
| Neither difficult | 46.0 | 43.1 |
| or easy | | |
| Difficult | 2.0 | 19.6 |
| Very difficult | — | — |
| Multiple response | | 2.0 |
| (easy/difficult) | | |

3. Test Subjects' Rating of Comfort During Removal.

| | | |
|---|---|---|
| Very Comfortable | 4.0 | 5.9 |
| Comfortable | 40.0 | 25.5 |
| Neither comfortable | 56.0 | 52.9 |
| or uncomfortable | | |
| Uncomfortable | — | 15.7 |
| Very uncomfortable | — | — |

Additionally, in another user study wherein test subjects who normally wear hydrocolloid-containing skin barriers were asked to rate the comfort level of the gel/PSA blend containing 90% gel/10% PSA (gel/PSA blend X), the gel/PSA blend was found to be markedly superior to the conventional hydrocolloid-containing adhesives, as noted by the responses in Table V below:

TABLE V
Test Subjects' Rating of Comfort of Gel/PSA Blend
Compared to Hydrocolloid-Containing Adhesive:

| | gel/PSA blend X Test |
|---|---|
| | Subjects' Response (%) |
| Much more comfortable | 26.9 |
| More comfortable | 23.1 |
| About the same comfort level | 41.0 |
| Less comfortable | 7.7 |
| Much less comfortable | 1.3 |

It should also be noted that in a prior study using the cross-linked silicone gel alone, without any PSA added, the gel failed the security requirement of 12 hours continuous wear, followed by a shower. Although the gel alone provided the desired skinfriendliness, it lacked the adhesive strength to withstand the effects of time and showering. Surprisingly, the addition of the PSA to the gel added sufficient adhesive strength without compromising the skinfriendly qualities of the gel alone.

1. A pressure sensitive adhesive composition comprising a compatible blend of (1) a cross-linked adhesive gel and (2) a pressure sensitive adhesive, wherein the pressure sensitive adhesive has a higher adhesive strength than said gel, and is blended with the gel during the cross-linking to form said gel.

2. The pressure sensitive adhesive composition of claim 1, comprising 40 wt. %-90 wt. % (1) and 10 wt. %-60 wt. % (2).

3. The pressure sensitive adhesive composition of claim 1, wherein the composition includes sufficient organic liquid to swell the adhesive gel.

4. A pressure sensitive adhesive composition comprising a compatible blend of (1) a cross-linked silicone gel comprising an organopolysiloxane reacted with a cross-liking agent; and (2) a silicone pressure sensitive adhesive, wherein the silicone pressure sensitive adhesive has a higher adhesive strength than said gel and is blended with said gel during the cross-linking to form said gel.

5. The pressure sensitive adhesive composition of claim 4, wherein the composition includes sufficient organic liquid to swell the silicone gel.

6. The pressure sensitive adhesive composition of claim 4, wherein the gel is a copolymer of a diorganosiloxane and an alkenyl siloxane.

7. The pressure sensitive adhesive composition of claim 6, wherein the diorganosiloxane is dimethylsiloxane, and the alkenyl siloxane comprises a vinyl siloxane.

8. The pressure sensitive adhesive composition of claim 4, wherein the gel is a copolymer of an organosiloxane and a siloxane having a plurality of reactive sites cross-linked with a hydrosilation agent.

9. The pressure sensitive adhesive composition of claim 8, wherein the hydrosilation agent is methylhydrogen siloxane.

10. The pressure sensitive adhesive composition of claim 8, wherein the cross-linking agent is a polymethylhydrogen siloxane fluid.

11. The pressure sensitive adhesive composition of claim 10, wherein the cross-linking agent is a trimethyl chainstopped polymethylhydrogen siloxane fluid having at least about 10% SiH groups.

12. The pressure sensitive adhesive composition of claim 4, wherein the essentially non-reactive silicone pressure sensitive adhesive (2) is essentially non-reactive with the organopolysiloxane of said gel or with the cross-linking agent of said gel and is a pre-reacted, condensation reaction product of an organopolysiloxane resin having a plurality of reactive moieties, and an organopolysiloxane having a reactive functional group that is reactive with a reactive moiety of said resin.

13. The pressure sensitive adhesive composition of claim 12, wherein the essentially non-reactive silicone pressure sensitive adhesive (2) comprises a reaction product of an organopolysiloxane resin containing silicon-bonded hydroxyl moieties, and the organopolysiloxane reacted with the resin contains a silicon-bonded hydroxyl reactive group.

14. The pressure sensitive adhesive composition of claim 13, wherein the organopolysiloxane resin is a polydimethylsiloxane containing about 1% to about 7% by weight hydroxyl functionalities, based on the weight of resin solids; and the organopolysiloxane reacted with the resin comprises a dimethylpolysiloxane containing a plurality of hydroxyl groups.

15. The pressure sensitive adhesive compositions of claim 14, wherein the dimethylpolysiloxane that is condensation reacted with the resin is silanol end-blocked and comprises at least 50 wt. % solids in an organic solvent.

16. The pressure sensitive adhesive composition of claim 12, wherein the organopolysiloxane reacted with the resin is end-blocked with a reactive group selected from the group consisting of silanol, and alkenyl.

17. The pressure sensitive adhesive composition of claim 16, wherein the organopolysiloxane, reacted with the resin, is vinyl end-capped.

18. The pressure sensitive adhesive composition of claim 4, containing 0.5% to 99.5% by weight of (1) and 99.5% to 0.5% of (2), based on the total weight of silicone pressure sensitive adhesive solids in the composition.

19. The pressure sensitive adhesive composition of claim 18, containing 40 wt. %-90 wt. % (1) and 10-60 wt. % (2).

20. A soft tacky skinfriendly sealant for removably securing body waste collectors and other objects to a wearer's skin, consisting essentially of a blend of a hypoallergenic silicone pressure sensitive adhesive and a compatible silicone gel; said silicone gel comprising a lightly cross-linked addition-polymerization reaction product of a poly(dimethylsiloxane-co-vinylsiloxane) and a methylhydrogen siloxane, with said gel constituting 0.5% to 99.5% by weight of said blend.

21. The sealant of claim 20 in which said gel constitutes about 40 to 90% by weight of said blend.

22. The sealant of claim 21 in which said gel constitutes about 50 to 80% by weight of said blend.

23. A collection pouch to be adhesively secured to a wearer's skin for collecting waste discharged through a natural or surgically-formed orifice; said pouch having side walls of liquid- and gas-impermeable flexible polymeric film with one of said walls being provided with an opening for receiving body waste; and attachment means attached to said pouch about said opening for removably attaching said pouch to a wearer's skin; said means comprising the pressure sensitive adhesive composition of claim 4.

24. The collection pouch of claim 23 in which said gel constitutes about 40 to 90% by weight of said blend.

25. The collection pouch of claim 24 in which said gel constitutes about 50 to 80% by weight of said blend.

26. A method of increasing the adhesive strength of a cross-linked gel during manufacture of said gel comprising blending a pressure sensitive adhesive, having more adhesive strength than the adhesive strength of the gel, with said gel during a cross-linking reaction used to form said gel.

27. A method of increasing the adhesive strength of a lightly cross-linked silicone gel during manufacture of said gel comprising blending a silicone pressure sensitive adhesive, having more adhesive strength than the adhesive strength of the gel, with said gel during a cross-linking reaction used to form said gel.

28. The method of claim 26, further including the step of shearing the blend sufficiently to form a homogeneous composition.

29. The method of claim 27, further including the step of shearing the blend sufficiently to form a homogeneous composition.

30. The method of claim 26, wherein the blended adhesives include sufficient organic liquid to swell the cross-linked gel.

31. The method of claim 30, wherein the gel is a cross-linked copolymer of a diorganosiloxane and an alkenyl siloxane.

32. The method of claim 31, wherein the alkenyl siloxane comprises a vinyl siloxane.

33. The method of claim 26, wherein the gel is cross-linked with a hydrosilation agent.

34. The method of claim 33, wherein the hydrosilation agent is a methylhydrogen siloxane.

35. The method of claim 34, wherein the hydrosilation agent is a polymethylhydrogen siloxane fluid.

36. The method of claim 35, wherein the cross-linking agent is a trimethyl chainstopped polymethylhydrogen siloxane fluid having at least about 10% SiH groups.

37. The method of claim 26, wherein the silicone pressure sensitive adhesive blended with the gel is essentially non-reactive with the cross-linking agent used to form said gel.

38. The method of claim 37, wherein the silicone pressure sensitive adhesive blended with the gel is a pre-reacted, condensation reaction product of an organopolysiloxane resin and an organopolysiloxane fluid.

39. The method of claim 38, wherein the essentially non-reactive silicone pressure sensitive adhesive (2) comprises a reaction product of an organopolysiloxane resin containing silicon-bonded hydroxyl moieties, and the organopolysiloxane reacted with the resin contains a silicon-bonded hydroxyl reactive group.

40. The method of claim 39, wherein the organopolysiloxane resin is a polydimethylsiloxane containing about 1% to about 7% by weight hydroxyl functionalities, based on the weight of resin solids; and the organopolysiloxane reacted with the resin comprises a dimethylpolysiloxane containing a plurality of hydroxyl groups.

41. The method of claim 38, wherein the dimethylpolysiloxane that is condensation reacted with the resin is silanol end-blocked and the cross-linked PSA gel comprises at least 50 wt. % solids in an organic solvent.

42. The method of claim 38, wherein the organopolysiloxane reacted with the resin is end-blocked with a reactive group selected from the group consisting of silanol, and alkenyl.

43. The method of claim 42, wherein the organopolysiloxane, reacted with the resin, is vinyl end-capped.

44. The method of claim 26, wherein the amount of silicone pressure sensitive adhesive blended with the gel, during cross-linking of the gel, comprises 0.5 wt. % to 99.5%, based on the total weight of gel and blended silicone pressure sensitive adhesive.

45. The method of claim 44, wherein the blend comprises 40 wt. % to 95 wt. % gel and 60 wt. % to 5 wt. % blended silicone pressure sensitive adhesive.

46. The method of claim 45 wherein the blend comprises 70 wt. % to 90 wt. % gel and 30 wt. % to 10 wt. % blended silicone pressure sensitive adhesive.

47. A method of adhering a device to human skin comprising coating at least a portion of the device, or a tape used to secure the device, with the composition of claim 1, and then contacting the coating against the skin.

48. A method of adhering a device to human skin comprising coating at least a portion of the device, or a tape used to secure the device, with the composition of claim 4, and then contacting the coating against the skin.

49. The method of claim 47, wherein the device is selected from the group consisting of an ostomy appliance, a patient monitoring device, a prosthetic device, a hairpiece, medical tape, a skin barrier sheet, a skin barrier ring, a male external catheter, a retracted penis pouch, a female continence device, a fecal pouch, a glans cap, a wound care dressing, a bandage, a burn dressing, surgical tape, ankle support tape, hand support tape, a transdermal drug delivery patch, scar therapy dressing, an island dressing, a reclosable wound cover, a foam dressing, tape to secure an I.V. needle, tape to secure a catheter, and means for securing a device to a breast.

50. The method of claim 48, wherein the device is selected from the group consisting of an ostomy appliance, a patient monitoring device, a prosthetic device, a hairpiece, medical tape, a skin barrier sheet, a skin barrier ring, a male external catheter, a retracted penis pouch, a female continence device, a fecal pouch, a glans cap, a wound care dressing, a bandage, a burn dressing, surgical tape, ankle support tape, hand support tape, a transdermal drug delivery patch, scar therapy dressing, an island dressing, a reclosable wound cover, a foam dressing, tape to secure an I.V. needle, tape to secure a catheter, and means for securing a device to a breast.
